(19) United States
(12) Patent Application Publication
(10) Pub. No.: US 2014/0219467 A1
(43) Pub. Date: Aug. 7, 2014

(54) MEDIA PLAYBACK SYSTEM HAVING WIRELESS EARBUDS

(71) Applicant: EARMONICS, LLC, Wayne, PA (US)

(72) Inventor: Adam M. KURTZ, Gladwyne, PA (US)

(73) Assignee: EARMONICS, LLC, Wayne, PA (US)

(21) Appl. No.: 14/174,243

(22) Filed: Feb. 6, 2014

Related U.S. Application Data
(60) Provisional application No. 61/762,193, filed on Feb. 7, 2013.

(51) Int. Cl. H04R 3/12

(52) U.S. Cl. CPC H04R 3/12
USPC 381/74

(57) ABSTRACT

A media playback system and methods of constructing and operating thereof are disclosed. The media playback system may include a first wireless earbud. The first wireless earbud may include a first speaker configured to be positioned substantially adjacent to a user's ear and transmit sound waves, a first control device configured to provide a control functionality, and a first wireless transceiver configured to provide wireless communication. The media playback system may further include a second wireless earbud. The second wireless earbud may include a second speaker configured to be positioned substantially adjacent to a user's ear and transmit sound waves, a second control device configured to provide a control functionality, and a second wireless transceiver configured to provide wireless communication.

### CROSS-REFERENCE TO RELATED APPLICATIONS

This application claims the priority benefit of U.S. Provisional Patent Application No. 61/762,193, filed Feb. 7, 2013 and entitled “Media Playback System Having Wireless Earbuds,” which is incorporated herein by reference in its entirety.

### BACKGROUND

With the increasing portability of music players and the like, users are frequently listening to music and/or other audio clips while on the go. One illustrative activity is listening to music while exercising. However, concerns of accidentally dropping and/or losing a portable audio player while performing activities, having the headphone cords become tangled on objects, or having the portable audio player and/or the headphones hindering movement of the wearer has become increasingly prevalent.

Previous solutions have resulted in the development of portable audio players that minimize these concerns. However, the solutions are somewhat bulky and integrate cables and/or other peripherals that do not completely eliminate the concerns of users.

### SUMMARY

In an embodiment, a media playback system may include a first wireless earbud and a second wireless earbud. The first wireless earbud may include a first speaker configured to be positioned substantially adjacent to a user's ear and transmit sound waves, a first control device configured to provide a control functionality, and a first wireless transceiver configured to provide wireless communication. The second wireless earbud may include a second speaker configured to be positioned substantially adjacent to a user's ear and transmit sound waves, a second control device configured to provide a control functionality, and a second wireless transceiver configured to provide wireless communication.

In an embodiment, a media playback system may include a first wireless earbud and a second wireless earbud. The first wireless earbud may include a first speaker configured to be positioned substantially adjacent to a user's ear and transmit sound waves, a first control device configured to provide a control functionality, and a first wireless transceiver configured to provide wireless communication. The second wireless earbud may include a second speaker configured to be positioned substantially adjacent to a user's ear and transmit sound waves, a second control device configured to provide a control functionality, and a second wireless transceiver configured to provide wireless communication. The media playback system may further include at least one connection device configured to connect the first wireless earbud to the second wireless earbud and a memory configured to contain at least one media file.

In an embodiment, a method constructing a media playback system may include providing a first earbud having a first speaker, a first control device, and a first wireless transceiver, providing a second earbud having a second speaker, a second control device, and a second wireless transceiver, and configuring the first earbud to communicate with the second earbud via the first wireless transceiver and the second wireless transceiver.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 depicts a first perspective view of an illustrative media playback system according to an embodiment.

FIG. 2 depicts a second perspective view of the media playback system according to an embodiment.

FIG. 3 depicts a bottom view of the media playback system according to an embodiment.

FIG. 4 depicts an outside view of the media playback system according to an embodiment.

FIG. 5 depicts an inside view of the media playback system according to an embodiment.

FIG. 6 depicts a side view of the media playback system according to an embodiment.

FIG. 7 depicts a block diagram of illustrative components in the media playback system according to an embodiment.

FIG. 8 depicts a perspective view of the media playback system when worn by a user according to an embodiment.

FIG. 9 depicts a flow diagram of an illustrative method of operating a pair of wireless earbuds according to an embodiment.

FIG. 10 depicts a flow diagram of an illustrative method of constructing a pair of wireless earbuds according to an embodiment.

### DETAILED DESCRIPTION

This disclosure is not limited to the particular systems, devices, and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The present disclosure relates generally to headphones and other user-wearable media devices, particularly those having media playback capabilities and an ability to wirelessly sync.

The following terms shall have, for the purposes of this application, the respective meanings set forth below.

An “electronic device” refers to a device that includes a processing device and tangible, computer-readable memory. The memory may contain programming instructions that, when executed by the processing device, cause the device to perform one or more operations according to the programming instructions. Examples of electronic devices include, but are not limited to, personal computers, gaming systems, televisions, home automation systems, and mobile devices. In some embodiments, the electronic device may further be configured to connect to a media playback system, as described in greater detail herein.

A “mobile device” refers to an electronic device that is generally portable in size and nature. Accordingly, a user may transport a mobile device with relative ease. Examples of mobile devices include pagers, cellular phones, feature phones, smartphones, personal digital assistants (PDAs), cameras, tablet computers, phone-tablet hybrid devices, laptop computers, netbooks, ultrabooks, global positioning satellite (GPS) navigation devices, in-dash automotive components, media players, watches, augmented reality devices, and/or the like. In some embodiments, the mobile device may further be configured to connect to the media playback system, as described in greater detail herein.

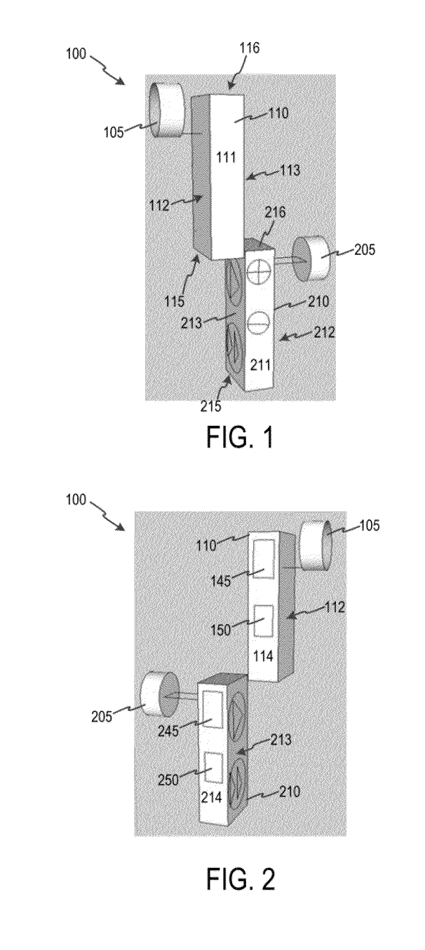

FIGS. 1 and 2 depict a first and a second perspective view, respectively, of a media playback system, generally designated 100, according to an embodiment. In various embodiments, the media playback system 100 may include a first (e.g., left) earbud 110 and a second (e.g., right) earbud 210. The first earbud 110 may include a first speaker 105 and may be configured to be worn in a wearer's left ear, for example. The second earbud 210 may include a second speaker 205 and may be configured to be worn in a wearer's right ear, for example. The first earbud 110 and the second earbud 210 may each include an attachment device to secure the earbud onto the respective ear so that they may be worn by a user without a fear of falling off, damage, and/or the like. Illustrative attachment devices may include, but are not limited to, hooks, protrusions, recessions, adhesives, and/or the like. Similarly, the first earbud 110 and the second earbud 210 may each be of any shape, size, and the like necessary to secure each earbud onto the respective ear.

In various embodiments, the first earbud 110 may include at least a front surface 111, an inside surface 112, an outside surface 113, a rear surface 114, a bottom surface 115, and a top surface 116. The front surface 111, when worn by a user as described in greater detail herein, may generally face in the same direction as the user's face (i.e., facing forward). In some embodiments, the front surface 111 may be devoid of any buttons, switches, ports, touch sensitive surfaces, antennae, and the like. In other embodiments, the front surface 111 may contain any number of buttons, switches, ports, touch sensitive surfaces, antennae, and the like, as described in greater detail herein.

In various embodiments, the inside surface 112 may generally face towards the user when worn, as described in greater detail herein. In some embodiments, the inside surface 112 may be devoid of buttons, switches, ports, and the like because of the inaccessibility of the inside surface when worn by a user. In some embodiments, the inside surface 112 may incorporate one or more antennae for wireless communication, as described in greater detail herein. In some embodiments, the inside surface 112 may include a connection device for affixing it to the inside surface 212 of the second earbud 210, as described in greater detail herein. In some embodiments, the inside surface 112 may be affixed to the first speaker 105. The inside surface 112 may include a means for providing electronic communication between the first speaker 105 and the first earbud 110 so that the first earbud may transmit electronic signals to the first speaker. In some embodiments, the electronic signals may be transmitted over a wired interface to the first speaker 105, where the wired interface is integrated with the inside surface 112 or passes through an opening in the inside surface. In other embodiments, the above components may be located on another surface of the first earbud 110.

In various embodiments, the first speaker 105 may generally be configured receive electronic signals and/or project the electronic signals as sound waves. In some embodiments, the first speaker 105 may additionally be configured to act as a microphone by receiving sound waves and transmitting electronic signals that correspond to the sound waves. In some embodiments, the first speaker 105 may be configured to project and receive sound waves substantially simultaneously. In other embodiments, the first speaker 105 may only project or receive sound waves at one time. In some embodiments, the first speaker 105 may be configured to transmit bone conduction signals to the user.

In various embodiments, the first speaker 105 may be of a shape and size that is suitable for placement in a human ear canal, on the outside of the human ear, and/or substantially surrounding the human ear. For example, the first speaker 105 may be sized and shaped to fit in the ear canal, over the ear canal, in the cavum conchae, between the tragus and the antitragus and/or the antihelix, in or on the crus of helix, over the pinna, and/or the like. The shape is not limited by this disclosure and may be any regular or irregular shape. Specific examples of a regular shape may include, for example, round, oval, oblong, or triangular shaped. Likewise, the size is not limited by this disclosure any may be any suitable size. Specific examples may include an average diameter of about 5 mm, about 10 mm, about 15 mm, about 20 mm, about 25 mm, about 30 mm, or any value or range between any two of these values (including endpoints).

In various embodiments, the second earbud 210 may include at least a front surface 211, an inside surface 212, an outside surface 213, a rear surface 214, a bottom surface 215, and a top surface 216. The front surface 211, when worn by a user as described in greater detail herein, may generally face in the same direction as the user's face (i.e., facing forward). In some embodiments, the front surface 211 may be devoid of any buttons, switches, ports, touch sensitive surfaces, antennae, and the like. In other embodiments, the front surface 211 may contain any number of buttons, switches, ports, touch sensitive surfaces, antennae, and the like, as described in greater detail herein.

In various embodiments, the inside surface 212 may generally face towards the user when worn, as described in greater detail herein. In some embodiments, the inside surface 212 may be devoid of buttons, switches, ports, and the like because of the inaccessibility of the inside surface when worn by a user. In some embodiments, the inside surface 212 may incorporate one or more antennae for wireless communication, as described in greater detail herein. In some embodiments, the inside surface 212 may include a connection device for affixing it to the inside surface 112 of the first earbud 110, as described in greater detail herein. In some embodiments, the inside surface 212 may be affixed to the second speaker 205. The inside surface 212 may include a means for providing electronic communication between the second speaker 205 and the second earbud 210 so that the second earbud may transmit electronic signals to the second speaker. In some embodiments, the electronic signals may be transmitted over a wired interface to the second speaker 205, where the wired interface is integrated with the inside surface 212 or passes through an opening in the inside surface. In other embodiments, the above components may be located on another surface of the second earbud 210.

In various embodiments, the second speaker 205 may generally be configured receive electronic signals and/or project the electronic signals as sound waves. In some embodiments, the second speaker 205 may additionally be configured to act as a microphone by receiving sound waves and transmitting electronic signals that correspond to the sound waves. In some embodiments, the second speaker 205 may be configured to project and receive sound waves substantially simultaneously. In other embodiments, the second speaker 205 may only project or receive sound waves at one time. In some embodiments, the second speaker 205 may be configured to transmit bone conduction signals to the user.

In various embodiments, the second speaker 205 may be of a shape and size that is suitable for placement in a human ear canal, on the outside of the human ear, and/or substantially surrounding the human ear. For example, the second speaker 205 may be sized and shaped to fit in the ear canal, over the ear canal, in the cavum conchae, between the tragus and the antitragus and/or the antihelix, in or on the crus of helix, over the pinna, and/or the like. The shape is not limited by this disclosure and may be any regular or irregular shape. Specific examples of a regular shape may include, for example, round, oval, oblong, or triangular shaped. Likewise, the size is not limited by this disclosure any may be any suitable size. Specific examples may include an average diameter of about 5 mm, about 10 mm, about 15 mm, about 20 mm, about 25 mm, about 30 mm, or any value or range between any two of these values (including endpoints).

In various embodiments, one or both of the front surface 111 of the first earbud 110 and the front surface 211 of the second earbud 210 may include one or more volume controls. The volume controls may generally be used to increase and/or decrease the volume of the sound emitted by the first speaker 105 and the second speaker 205. In some embodiments, the volume controls may be buttons, switches, touch surfaces, rockers, and/or the like, as described in greater detail herein. In other embodiments, the volume controls may be located on another surface of the earbuds.

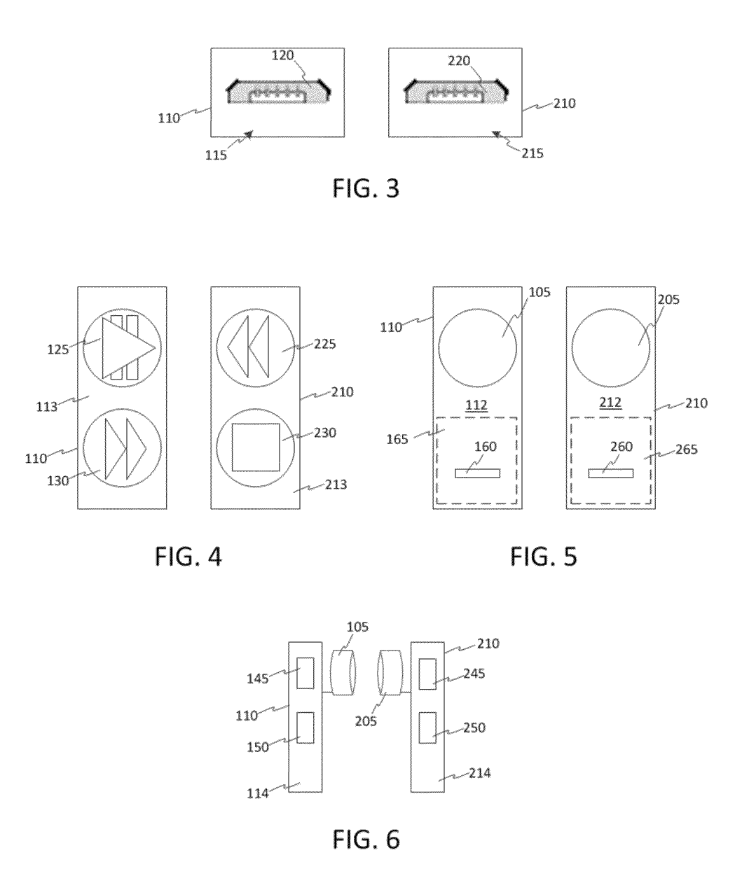

FIG. 3 depicts a bottom view of the media playback system according to an embodiment. In some embodiments, the bottom surface 115 of the first earbud 110 may include a communications port 120. Likewise, in some embodiments, the bottom surface 215 of the second earbud 210 may include a communications port 220. In some embodiments, the communications ports 120, 220 may provide electronic communication between the respective earbud 110, 210 and an external device, such as, for example, a personal computer, a server, a standalone audio device, an electronic device, a mobile device, and/or the like. In some embodiments, the communications port 120 on the first earbud 110 may provide electronic communication to the communications port 220 on the second earbud 210 and vice versa. In some embodiments, the communications ports 120, 220 may provide an interface for the transfer of electronic data, such as files, audio packets, and/or the like. In some embodiments, the communications ports 120, 220 may provide an interface for charging and/or providing electrical power to the respective earbud 110, 210. In some embodiments, each earbud 110, 210 may incorporate a battery therein, and the communications ports 110, 120 may be configured to charge the respective batteries. The communications ports 120, 220 are not limited by this disclosure, and may use any type of electronic communication now known or later developed. Specific examples of communications ports 120, 220 may include universal serial bus (USB), as well as micro-(micro-USB) and mini-(mini-USB) variants thereof, Ethernet, Human Interface Link (HIL), Musical Instrument Digital Interface (MIDI), Multibus, RS-232 (serial port), DMX512-A, IEEE-488 General Purpose Interface Bus (GPIB), EIA/RS-422, IEEE-1284 (parallel port), UNI/O, ACCESS.bus, 1-Wire, Inter-Integrated Circuit (I²C), Serial Peripheral Interface Bus (SPI), RS-485, any Small Computer System Interface (SCSI), Process Field Bus (Profibus), FireWire (1394), Fibre Channel, Camera Link, Peripheral Component Interconnect Express (PCI Express), Thunderbolt, and the like. In other embodiments, the communications ports 120, 220 may use a wireless interface. Specific examples of wireless interfaces may include radio frequency (RF), infrared, near field communication (NFC), Bluetooth, any IEEE 802.15 protocol, any IEEE 802.11 protocol, any IEEE 802.16 protocol, Direct Sequence Spread Spectrum (DSSS), Frequency Hopping Spread Spectrum (FPSS), cellular communication protocols, paging network protocols, magnetic induction, satellite data communication protocols, Wireless Medical Telemetry Service (WTMS), Universal Mobile Telecommunications System (UMTS), Global System for Mobile Communications (GSM), General Packet Radio Service (GPRS), and the like.

FIG. 4 depicts an outside view of the media playback system according to an embodiment. The respective outside surfaces 113, 213 of the first earbud 110 and second earbud 210 may each include one or more controls 125, 130, 225, 230. The controls 125, 130, 225, 230 described herein are merely illustrative and those skilled in the art will recognize that alternative controls may be possible without departing from the scope of this disclosure. In some embodiments, the one or more controls 125, 130, 225, 230 may provide one or more controls to the first earbud 110 and/or the second earbud 210. Specific examples of the one or more controls may include playback controls such as play, pause, stop, fast forward, rewind, next track, previous track, repeat, skip, and the like, radio tuning controls, radio preset controls, device power controls, device communication controls such as turning the device on/off, turning device components on/off, turning device features on/off, volume adjustment, controlling external devices, and/or the like. In some embodiments, the one or more controls 125, 130, 225, 230 may be activated by any combination of buttons, toggles, switches, and touch commands, such as by using a touch sensitive interface. Specific examples of a touch sensitive interface may include resistive interfaces, surface acoustic wave interfaces, capacitive interfaces, infrared grid interfaces, infrared acrylic projection interfaces, optical imaging interfaces, dispersive signal interfaces, and acoustic pulse recognition interfaces. In some embodiments, the touch sensitive interface may be integrated with a display screen and/or surface. In some embodiments, the touch sensitive interface may include a single-point touch interface. In other embodiments, the touch sensitive interface may include a multi-point touch (multitouch) interface.

In some embodiments, the respective outside surfaces 113, 213 of the first earbud 110 and second earbud 210 may each have a display. In some embodiments, the display may be used to display the type of control 125, 130, 225, 230, text, pictographic descriptions, images, moving images, video, and/or the like. In some embodiments, the display may be configured to operate in conjunction with the touch sensitive interface, and may change what is displayed based upon various gestures received by the touch sensitive interface. Specific examples of displays may include electroluminescent displays, electronic paper displays, vacuum fluorescent displays, light emitting diode (LED) displays, cathode ray tube (CRT) displays, liquid crystal displays (LCDs), plasma display panels, digital light processing (DLP) displays, and organic light-emitting diode (OLED) displays.

FIG. 5 depicts an inside view of the media playback system according to an embodiment. As previously described herein, the inside surfaces 112, 212 of the first 110 and second 210 earbuds, respectively, may face the user when worn according to an embodiment. The inside surfaces 112, 212 may each include one or more wireless transceivers 160, 260. In some embodiments, the one or more wireless transceivers 160, 260 may provide wireless communication between the earbuds 110, 210 or between one or both of the earbuds and an electronic device, such as a music player, a mobile phone, a personal computer, a wireless remote control, and/or the like. Specific examples of the one or more wireless transceivers 160, 260 may include antennae, infrared (IR) ports, radio transmitters, radio receivers, and/or the like. Specific examples of wireless communication may include, but are not limited to, radio frequency (RF), infrared, near field communication (NFC), Bluetooth, any IEEE 802.15 protocol, any IEEE 802.11 protocol, any IEEE 802.16 protocol, Direct Sequence Spread Spectrum (DSSS), Frequency Hopping Spread Spectrum (FPSS), cellular communication protocols, paging network protocols, magnetic induction, satellite data communication protocols, Wireless Medical Telemetry Service (WTMS), Universal Mobile Telecommunications System (UMTS), Global System for Mobile Communications (GSM), General Packet Radio Service (GPRS), and the like. In some embodiments, the one or more wireless transceivers 160, 260 may be embedded within one or both of the inside surfaces 112, 212. In other embodiments, the one or more wireless transceivers 160, 260 may be placed on one or both of the inside surfaces 112, 212. In other embodiments, the one or more wireless transceivers 160, 260 may be located inside the first 110 and/or second 210 earbuds, as described in greater detail herein.

In various embodiments, the inside surfaces 112, 212 may each have a connection device 165, 265. In some embodiments, the connection devices 165, 265 may attach the first earbud 110 to the second earbud 210 when not in use, as previously described herein. In some embodiments, the connection devices 165, 265 may prevent one of the earbuds 110, 210 from getting lost. In some embodiments, the connection devices 165, 265 may include any number and/or combination of hooks, loops, adhesives, magnetic materials, and the like.

FIG. 6 depicts a side view of the media playback system according to an embodiment. In some embodiments, the rear surface 114 of the first earbud 110 may include one or more controls 145. Similarly, in some embodiments, the rear surface 214 of the second earbud 210 may include one or more controls 245. Specific examples of the one or more controls 145, 245 may include playback controls such as play, pause, stop, fast forward, rewind, next track, previous track, repeat, skip, and the like, radio tuning controls, radio preset controls, device power controls, device communication controls such as turning the device on/off, turning device components on/off, turning device features on/off, volume adjustment, controlling external devices, and/or the like. In some embodiments, the one or more controls 145, 245 may be activated by any combination of buttons, toggles, switches, and touch commands, such as by using a touch sensitive interface. Specific examples of a touch sensitive interface may include resistive interfaces, surface acoustic wave interfaces, capacitive interfaces, infrared grid interfaces, infrared acrylic projection interfaces, optical imaging interfaces, dispersive signal interfaces, and acoustic pulse recognition interfaces. In some embodiments, the touch sensitive interface may be integrated with a display screen and/or surface. In some embodiments, the touch sensitive interface may include a single-point touch interface. In other embodiments, the touch sensitive interface may include a multi-point touch (multitouch) interface.

In some embodiments, the rear surface 114 of the first earbud 110 may include one or more ports 150. Similarly, in some embodiments, the rear surface 214 of the second earbud 210 may include one or more ports 250. The one or more ports 150, 250 are not limited by this disclosure, and may include any type of port. Specific examples of ports may include communications ports, electrical ports, and/or the like.

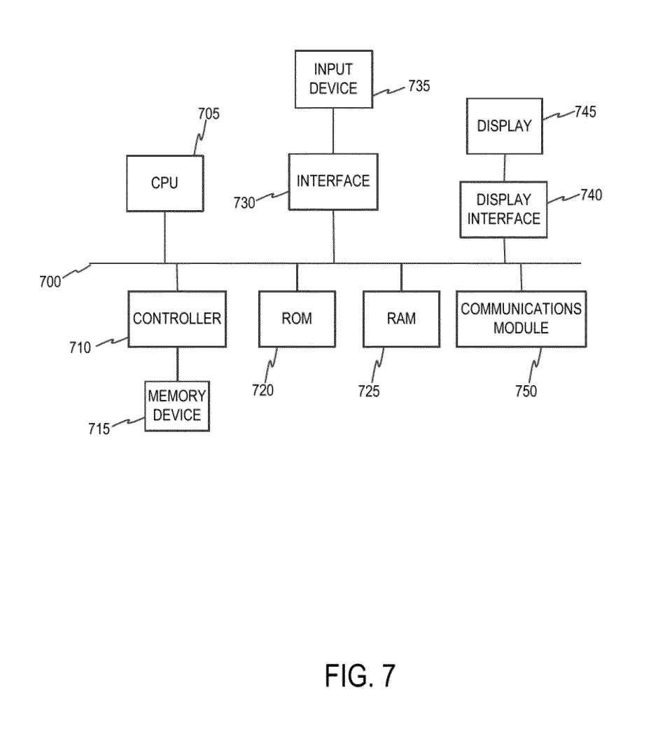

FIG. 7 depicts a block diagram of illustrative components in each of the pair of wireless earbuds according to an embodiment. In some embodiments, the earbuds 110, 210 (FIGS. 1-6) may have identical components. In other embodiments, the first earbud 110 may have different components than the second earbud 210. The components described herein are merely illustrative; thus fewer, greater, or other components are contemplated without departing from the scope of the present disclosure. Specific examples of other components not specifically enumerated herein may include a power supply (e.g., batteries and the like).

In various embodiments, the earbuds 110, 210 (FIGS. 1-6) may generally include one or more of a CPU 705, a controller 710, a memory device 715, ROM 720, RAM 725, an interface 730, a display interface 740, and a communications module 750. A bus 700 may serve as an information highway interconnecting the modules and/or elements of the earbuds 110, 210 (FIGS. 1-6).

In various embodiments, the CPU 705 may generally be any processing device that executes one or more operations based on programming instructions stored in one or more of the read only memory (ROM) 720, the random access memory (RAM) 725, and the memory device 715. In some embodiments, the one or more operations may be completed by the CPU 705, or the CPU may direct other components to complete the operations, as described in greater detail herein. In some embodiments, read only memory (ROM) 720 and random access memory (RAM) 725 may constitute illustrative memory devices (i.e., processor-readable non-transitory storage media).

In various embodiments, the CPU 705 may include any number of hardware, software and/or firmware components, as well as any number of logical or functional modules. In some embodiments, the CPU 705 may be, for example, a general purpose processing device, a digital signal processor, an application-specific integrated circuit, a field programmable gate array (FPGA), a programmable logic device, a logic gate, and/or combinations thereof. In some embodiments, the CPU 705 may further be a microprocessor, a controller, a microcontroller, a state machine or any combination thereof.

In various embodiments, the interface 730 may include, for example, one or more user interface components, such as an input device 735, that may generally be configured to elicit one or more commands to one or both of the earbuds 110, 210 when actuated. Examples of user interface components may include the one or more controls 125, 130, 145, 225, 230, 245 (FIGS. 1-6) as previously described herein.

In some embodiments, the input device 735 may further include a touch sensitive surface, as described in greater detail herein. The touch sensitive surface may receive contact based inputs from a user, such as from a user's fingers, a stylus, and/or the like. The touch sensitive surface may be adapted for gesture control, thus allowing for a user to tap, pinch, swipe or provide other similar gestures to elicit commands to one or both of the earbuds 110, 210 (FIGS. 1-6). The touch sensitive surface may further be capable of sending touch commands to the CPU 705. In some embodiments, the interface 730 may also be configured to receive commands via body gestures, voice, audio signals, device movement and/or the like, which may be completed through the use of microphones, speakers, cameras, barometers, gyroscopes and/or the like.

In various embodiments, the display 745 may be used to display images, text, and/or the like to a user. As shown, display 745 may be connected to bus 700 via display interface 740. Examples of display elements may include, but are not limited to, electroluminescent displays, electronic paper displays, vacuum fluorescent displays, light emitting diode (LED) displays, cathode ray tube (CRT) displays, liquid crystal displays (LCDs), plasma display panels, digital light processing (DLP) displays, and organic light-emitting diode (OLED) displays.

In various embodiments, the communications module 750 may generally provide an interface between two or more of the first earbud 110, the second earbud 210 (FIGS. 1-6), and other electronic devices, mobile devices, and/or the like. In some embodiments, the communications module 750 may provide a connection to a communications network, such as, the Internet, an intranet, and/or the like. In some embodiments, the communications module 750 may be configured to process data transmitted or received via a wired and/or a wireless interface. The wired interface may include, but is not limited to, Ethernet, Human Interface Link (HIL), Musical Instrument Digital Interface (MIDI), Multibus, RS-232 (serial port), DMX512-A, IEEE-488 General Purpose Interface Bus (GPIB), EIA/RS-422, IEEE-1284 (parallel port), UNI/O, ACCESS.bus, 1-Wire, Inter-Integrated Circuit (I²C), Serial Peripheral Interface Bus (SPI), RS-485, any Small Computer System Interface (SCSI), Process Field Bus (Profibus), Universal Serial Bus (USB), FireWire (1394), Fibre Channel, Camera Link, Peripheral Component Interconnect Express (PCI Express), Thunderbolt and the like. The wireless interface may include, but is not limited to, radio frequency (RF), infrared, near field communication (NFC), Bluetooth, any IEEE 802.15 protocol, any IEEE 802.11 protocol, any IEEE 802.16 protocol, Direct Sequence Spread Spectrum (DSSS), Frequency Hopping Spread Spectrum (FPSS), cellular communication protocols, paging network protocols, magnetic induction, satellite data communication protocols, Wireless Medical Telemetry Service (WTMS), Universal Mobile Telecommunications System (UMTS), Global System for Mobile Communications (GSM), General Packet Radio Service (GPRS) and the like.

In some embodiments, the controller 710 may interface with one or more optional memory devices 715 to the system bus 700. Specific examples of memory devices may include, but are not limited to, random access memory (RAM) 725, read only memory (ROM) 720, erasable programmable read only memory (EPROM), electric erasable programmable read only memory (EEPROM), flash memory, magnetic computer storage devices, optical discs, hard disks, removable disks, solid state drives and the like. As indicated previously, these various drives and controllers are optional devices.

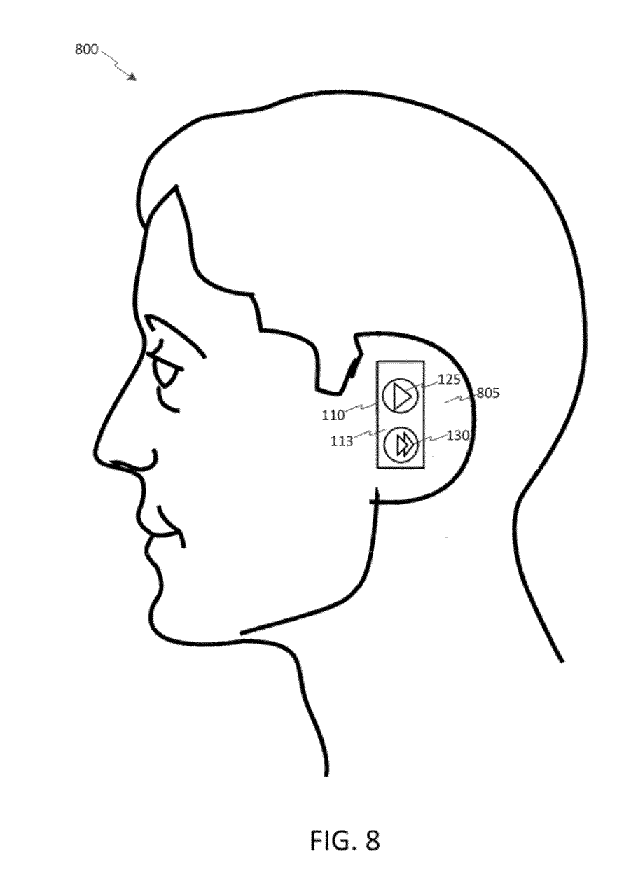

FIG. 8 depicts a perspective view of the media playback system when worn by a user according to an embodiment. In various embodiments, the user 800 may place the earbud 110 over, in, or around his left ear 805, as described in greater detail herein. In some embodiments, the outside surface 113 of the earbud 110 may generally face away from the user 800 so that the user can access the one or more controls 125, 130 while wearing the earbud 110 without having to remove it from his ear 805.

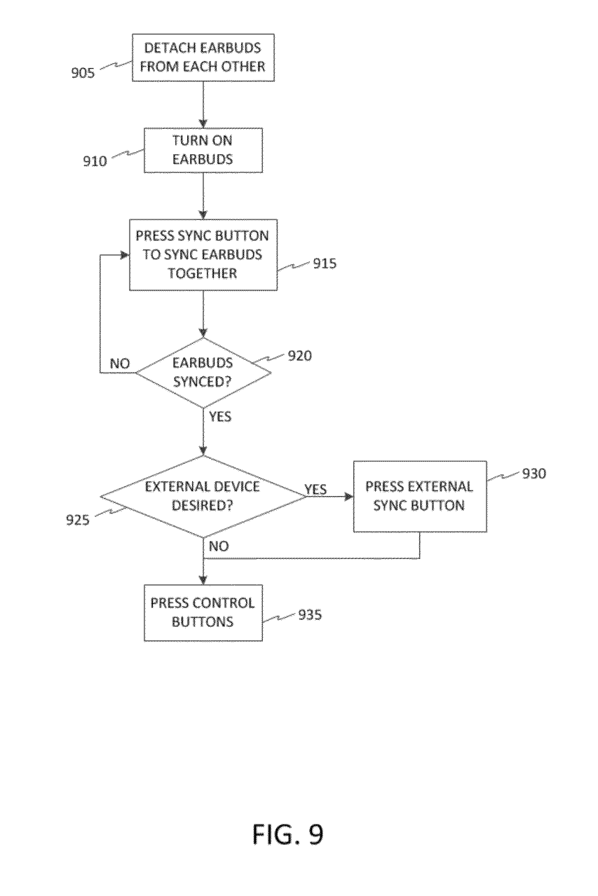

FIG. 9 depicts a flow diagram of an illustrative method of operating a pair of wireless earbuds according to an embodiment. In some embodiments, the method described in FIG. 9 may generally be completed by the user of the earbuds. The processes described herein with respect to FIG. 9 are merely illustrative; those skilled in the art will recognize that fewer, additional, or alternative steps may be completed without departing from the scope of the present disclosure.

The user may detach 905 the earbuds from each other. Detachment 905 may include, for example, moving components, deactivating components, applying pressure to components, and/or the like. The user may turn 910 the earbuds on, such as, for example, by pressing a power control on one or both of the earbuds.

If the earbuds have not been previously synced together, the user may have to press 915 a control button on one or both of the earbuds to sync them together. In an alternative embodiment, the user may sync the earbuds by connecting them into a device, such as a computer or the like to have a software program sync them together, load audio files onto them, charge batteries incorporated within, and/or the like. The user may verify 920 that the earbuds have been synced, and if they have not, may press 915 the buttons again to ensure that they are synced.

If the user desires 925 to use the earbuds with an external device, such as a mobile phone or a portable media player, he/she may press 930 an external sync button to effect syncing of the earbuds to the external device. Once the earbuds have been synced together, and optionally synced to the external device, the user may press the control buttons 935 on one or more of the earbuds to effect playback of media files.

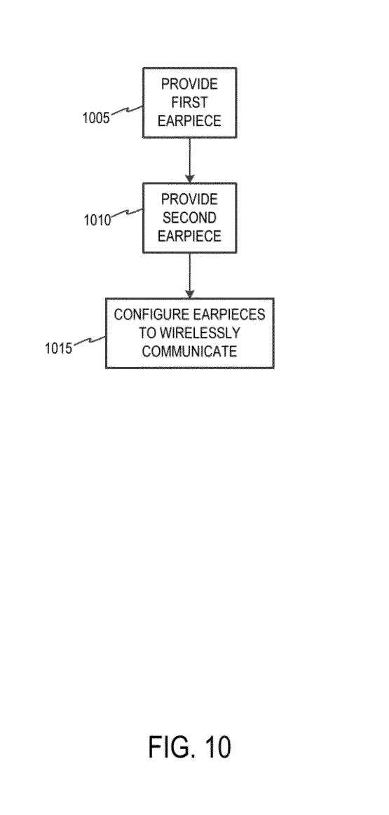

FIG. 10 depicts a flow diagram of an illustrative method of constructing a pair of wireless earbuds according to an embodiment. In some embodiments, the processes described with respect to FIG. 10 may be completed by one or more persons, one or more machines, and/or the like. The processes described herein with respect to FIG. 10 are merely illustrative; those skilled in the art will recognize that fewer, additional, or alternative steps may be completed without departing from the scope of the present disclosure.

In various embodiments, the first earpiece may be provided 1005. Providing 1005 the first earpiece may include one or more of providing components, arranging components, attaching components, fabricating components, assembling components, and/or the like. The various components may generally be the components described in greater detail herein. In various embodiments, the second earpiece may be provided 1010. In some embodiments, providing 1010 the second earpiece may be similar to that of the first earpiece, but may contain different or alternative components and processes for assembly thereof.

Once the earpieces have been provided 1005, 1010, the earpieces may be configured 1015 to wirelessly communicate with each other and/or with other devices, as described in greater detail herein. The configuring 1015 may include, for example, programming the earpieces to recognize each other and sync together, recognize other devices and sync with them, and may include other steps of physically connecting the earpieces together to ensure wireless connectivity once the earpieces are used by the user.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example), the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A media playback system, the media playback system comprising:
a first wireless earbud comprising:
a first speaker configured to be positioned substantially adjacent to a user's ear and transmit sound waves,
a first control device configured to provide a control functionality, and
a first wireless transceiver configured to provide wireless communication; and
a second wireless earbud comprising:
a second speaker configured to be positioned substantially adjacent to a user's ear and transmit sound waves,
a second control device configured to provide a control functionality, and
a second wireless transceiver configured to provide wireless communication.

2. The media playback system of claim 1, wherein the first wireless transceiver is further configured to communicate with the second wireless transceiver.

3. The media playback system of claim 1, further comprising:
a first attachment device connected to the first wireless earbud; and
a second attachment device connected to the second wireless earbud,
wherein the first attachment device and the second attachment device are each configured to attach to the user's ear.

4. The media playback system of claim 1, wherein the first wireless earbud further comprises a communications port configured to provide electronic communication between the first wireless earbud and an external device.

5. The media playback system of claim 1, wherein the second wireless earbud further comprises a communications port configured to provide electronic communication between the second wireless earbud and an external device.

6. The media playback system of claim 1, wherein the first wireless earbud further comprises a display configured to display at least one of a control, text, a pictographic description, an image, a moving image, and a video.

7. The media playback system of claim 6, wherein the display is a touch sensitive display.

8. The media playback system of claim 1, wherein the second wireless earbud further comprises a display configured to display at least one of a control, text, a pictographic description, an image, a moving image, and a video.

9. The media playback system of claim 8, wherein the display is a touch sensitive display.

10. A media playback system, the media playback system comprising:
a first wireless earbud comprising:
a first speaker configured to be positioned substantially adjacent to a user's ear and transmit sound waves,
a first control device configured to provide a control functionality,
a first wireless transceiver configured to provide wireless communication;
a second wireless earbud comprising:
a second speaker configured to be positioned substantially adjacent to a user's ear and transmit sound waves,
a second control device configured to provide a control functionality, and
a second wireless transceiver configured to provide wireless communication;
at least one connection device configured to connect the first wireless earbud to the second wireless earbud; and
a memory configured to contain at least one media file.

11. The media playback system of claim 10, wherein the first wireless transceiver is further configured to communicate with the second wireless transceiver.

12. The media playback system of claim 10, wherein the at least one connection device is a magnetic connection device.

13. The media playback system of claim 10, further comprising:
a first attachment device connected to the first wireless earbud; and
a second attachment device connected to the second wireless earbud,
wherein the first attachment device and the second attachment device are each configured to attach to the user's ear.

14. The media playback system of claim 10, wherein the first wireless earbud further comprises a communications port configured to provide electronic communication between the first wireless earbud and an external device.

15. The media playback system of claim 10, wherein the second wireless earbud further comprises a communications port configured to provide electronic communication between the second wireless earbud and an external device.

16. The media playback system of claim 10, wherein the first wireless earbud further comprises a display configured to display at least one of a control, text, a pictographic description, an image, a moving image, and a video.

17. The media playback system of claim 16, wherein the display is a touch sensitive display.

18. The media playback system of claim 10, wherein the second wireless earbud further comprises a display configured to display at least one of a control, text, a pictographic description, an image, a moving image, and a video.

19. The media playback system of claim 18, wherein the display is a touch sensitive display.

20. A method of constructing a media playback system, the method comprising:
providing a first earbud comprising a first speaker, a first control device, and a first wireless transceiver;
providing a second earbud comprising a second speaker, a second control device, and a second wireless transceiver; and
configuring the first earbud to communicate with the second earbud via the first wireless transceiver and the second wireless transceiver.
